(19) United States
(12) Patent Application Publication
(10) Pub. No.: US 2026/0016804 A1
(43) Pub. Date: Jan. 15, 2026

(54) MOTOR CONTROL DEVICE

(71) Applicant: FANUC CORPORATION, Minamitsuru-gun, Yamanashi (JP)

(72) Inventor: Mizuki SUGIMOTO, Yamanashi (JP)

(73) Assignee: FANUC CORPORATION, Minamitsuru-gun, Yamanashi (JP)

(21) Appl. No.: 18/994,454

(22) PCT Filed: Sep. 13, 2022
(86) PCT No.: PCT/JP2022/034161

§ 371 Date: Jan. 14, 2025

(51) Int. Cl. G05B 19/18

(52) U.S. Cl. CPC G05B 19/182; G05B 2219/49384

(57) ABSTRACT

The present invention provides a technology that can reduce a shock of a machine tool caused by a sharp change in acceleration at the time of oscillation mode switching in oscillation machining. A motor control device 1 comprises: an oscillation command calculation unit 12 that calculates an oscillation command from a movement command and an oscillation condition; an oscillation mode switching determination unit 32 that determines a timing of finishing the oscillation or switching a machining path; a filter time constant/application time setting unit 31 that sets a time constant τ and an application time to of a filter; a filter coefficient calculation unit 33 that calculates a filter coefficient K on the basis of the time constant τ set by the filter time constant/application time setting unit 31; and a filter application unit 34 that applies a filter having the filter coefficient K to a command for driving a motor 2 during the application time to when the oscillation mode switching determination unit 32 determines that the switching timing has been reached.

### TECHNICAL FIELD

The present invention relates to a motor control device.

### BACKGROUND ART

Conventionally, upon cutting a workpiece using a cutting tool, the continuously generated chips have been known to entangle with the cutting tool, and be a cause of machining defects and failure of machine tools. To address this, oscillation cutting, which shreds the chips by cutting while oscillating the cutting tool and the workpiece relative to each other, has been proposed (for example, refer to Patent Document 1).

### CITATION LIST

### Patent Document

Patent Document 1: Japanese Unexamined Patent Application, Publication No. 2011-123616

### DISCLOSURE OF THE INVENTION

### Problems to be Solved by the Invention

As a means for realizing oscillation cutting, a technique has been adopted which superimposes an oscillation command on a movement command. With this technique, at the time of switching the oscillation mode such as oscillation end or a machining path switching during oscillation cutting, a discontinuous command is generated depending on the oscillation phase, and thus the acceleration may abruptly change. There is also concern over a sharp change in acceleration causing a shock to the machine tool. There has been room for improvement in the conventional technology.

The present disclosure has been made taking account of the above problems, and has an object of providing technology which can reduce the shock to a machine tool caused by a sharp change in acceleration at the time of oscillation mode switching in oscillation machining.

### Means for Solving the Problems

The present disclosure relates to a motor control device for a machine tool that controls a motor to perform oscillation machining, the motor control device including: an oscillation command calculation unit that calculates an oscillation command from a movement command and an oscillation condition; a switching determination unit that determines an oscillation end or a switching timing of a machining path; a setting unit that sets a time constant and an application time of a filter; a filter coefficient calculation unit that calculates a coefficient of a filter based on a time constant which was set by the setting unit; and a filter application unit that, in a case of being determined by the switching determination unit as being the switching timing, applies a filter of the filter coefficient to a command for driving the motor during the application time.

### Effects of the Invention

According to the present disclosure, it is possible to provide technology which can reduce the shock to a machine tool caused by a sharp change in acceleration at the time of oscillation mode switching in oscillation machining.

### BRIEF DESCRIPTION OF THE DRAWINGS

FIG. 1 is a functional block diagram of a motor control device for a machine tool according to a first embodiment;

FIG. 2 is a graph showing a movement command;

FIG. 3 is a graph showing a sinewave oscillation command;

FIG. 4 is a graph of a superposition command made by superimposing the movement command and the oscillation command of a conventional motor control device;

FIG. 5 is a graph showing a movement command;

FIG. 6 is a graph showing an offset cosine wave oscillation command;

FIG. 7 is a graph of a superposition command made by superimposing the movement command and the oscillation command of a conventional motor control device;

FIG. 8 is a functional block diagram of a motor control device for a machine tool according to a second embodiment;

FIG. 9 is a functional block diagram of a motor control device for a machine tool according to a third embodiment; and

FIG. 10 is a functional block diagram of a motor control device for a machine tool according to a fourth embodiment.

### PREFERRED MODE FOR CARRYING OUT THE INVENTION

Hereinafter, embodiments of the present disclosure will be described in detail while referencing the drawings. It should be noted that, in the descriptions of the second and later embodiments, the same reference symbols are attached to configurations shared with the first embodiment, and descriptions thereof will be omitted as appropriate.

### FIRST EMBODIMENT

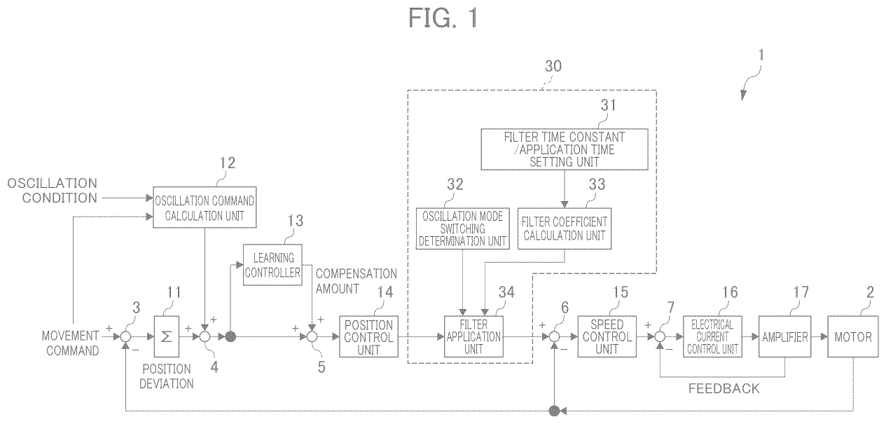

FIG. 1 is a functional block diagram of a motor control device 1 for a machine tool according to a first embodiment. The motor control device 1 according to the first embodiment performs oscillation cutting on a workpiece by way of a tool, by operating at least one spindle that causes a cutting tool and a workpiece to rotate relative to each other, and at least one feed axis that causes the cutting tool to move relatively to the workpiece.

The motor control device 1 for a machine tool is configured using a computer including memory such as ROM (read only memory) and RAM (random access memory), a CPU (control processing unit), a communication control unit, and the like, which are mutually connected via a bus, for example. The functions and operations of the functional units described below are achieved by cooperation of a CPU and memory, which are built into the computer, and the control programs stored in the memory. The motor control device 1 for a machine tool may be configured by a CNC (Computer Numerical Controller), and may be connected to a higher-order computer (not shown) such as a CNC or a PLC (Programmable Logic Controller). In addition to machining programs, the machining conditions such as rotation speed are input to the motor control device 1 for a machine tool from the higher-order computer.

It should be noted that, for convenience, FIG. 1 only shows a motor 2 which drives one feed axis. In addition, in the cutting processing according to the present embodiment, the shape of the workpiece is not limited. In other words, it is applicable even in a case of a plurality of feed axes (Z axis and X axis) being required due to the workpiece having a tapered part or arc-shaped part on the machined surface, or a case of the workpiece being columnar or cylindrical, and one specific axis (Z axis) being sufficient as the feed axis.

As shown in FIG. 1, the motor control device 1 for a machine tool according to the first embodiment includes, as functional units, a position deviation processing unit 3, an integration unit 11, an oscillation command calculation unit 12, a command synthesis unit 4, a learning controller 13, a learning compensation value adding unit 5, a position control unit 14, a filter processing unit 30, a speed deviation processing unit 6, a speed control unit 15, an electrical current deviation processing unit 7, an electrical current control unit 16, and an amplifier 17.

The position deviation processing unit 3 calculates a deviation between the position of the motor 2 of the feed axis indicated by the current movement command, and an actual position feedback value that is fed back from the motor 2 of the feed axis. The movement command is, for example, a command indicating machining conditions such as information on a feed amount of the cutting tool. The movement command is acquired from, for example, a machining program stored in a storage unit (not shown), a setting parameter of the machine tool, an external computer, or a combination of these.

The integration unit 11 integrates the position deviation calculated by the position deviation processing unit 3, and outputs the movement command subjected to the position deviation processing.

The oscillation command calculation unit 12 calculates an oscillation command based on the inputted movement command and the inputted oscillation condition. The oscillation command is a command for causing the feed axis to undergo reciprocal motion based on the oscillation phase. The oscillation command calculation unit 12 can set the oscillation command to a value obtained by multiplying the sine (sin 0) or cosine (cos 0) of the oscillation phase by a constant (oscillation amplitude) [mm]. The oscillation condition is acquired from, for example, a machining program stored in a storage unit (not shown), a setting parameter of the machine tool, an external computer, or a combination thereof.

The command synthesis unit 4 calculates a superposition command, which is a command for driving the motor 2, by superimposing the movement command subjected to the position deviation processing by the integration unit 11 and the oscillation command outputted by the oscillation command calculation unit 12.

The learning controller 13 calculates a compensation amount based on the superposition command outputted from the command synthesis unit 4. The learning controller 13 includes, for example, memory, and stores the oscillation phase and the compensation amount in one cycle or a plurality of cycles of the oscillation in the memory to be associated with each other, and reads the superposition command stored in the memory at a timing which can compensate the phase delay of the oscillation operation according to the responsiveness of the motor 2, and outputs this as the compensation amount. When an oscillation phase for outputting the compensation amount does not exist in the oscillation phases stored in the memory, the compensation amount to be outputted may be calculated from the compensation amounts having close oscillation phases.

The learning compensation value adding unit 5 adds the compensation value calculated by the learning controller 13 to the superposition command synthesized by the command synthesis unit 4. In general, since the position deviation with respect to the oscillation command becomes larger as the oscillation frequency becomes higher, it is possible to improve the followability with respect to the periodic oscillation command by adding the compensation amount calculated by the learning controller 13 to the superposition command.

The position control unit 14 outputs a speed command based on the superposition command to which the compensation value was added.

In the first embodiment, the filter processing unit 30 performs filter processing on the speed command outputted by the position control unit 14. It should be noted that the details of the filter processing unit 30 will be described later.

The speed deviation processing unit 6 obtains a difference between the speed command value outputted from the position control unit 14 and filtered by the filter processing unit 30, and an actual speed feedback value that is fed back from the motor 2 of the feed axis, and outputs this difference as a speed deviation.

The speed control unit 15 generates and outputs an electrical current command value based on the speed deviation outputted by the speed deviation processing unit 6. The electrical current command value is also referred to as a torque command value due to determining the torque of the motor 2.

The electrical current deviation processing unit 7 obtains a difference between the electrical current command value outputted from the speed control unit 15 and the electrical current feedback value from the amplifier 17, and outputs this difference to the electrical current control unit 16 as an electrical current deviation.

The electrical current control unit 16 generates an electrical current value based on the electrical current deviation and outputs this to the amplifier 17.

The amplifier 17 calculates a desired electric power based on the electrical current value from the electrical current control unit 16, and inputs this to the motor 2.

Next, the filter processing unit 30 will be described. The filter processing unit 30 includes a filter time constant/application time setting unit 31, an oscillation mode switching determination unit 32, a filter coefficient calculation unit 33, and a filter application unit 34.

The filter time constant/application time setting unit 31 sets a filter time constant and an application time. The filter time constant and the application time are set as fixed values in advance in consideration of, for example, shock generated in the machine tool, machining conditions, and oscillation conditions. In addition, the filter time constant and the application time may be configured to be automatically set based on a parameter set in the machine tool, a machining program, or the like. It should be noted that the details of a method of setting the filter time constant and the application time will be described later.

The oscillation mode switching determination unit 32 determines whether or not being a switching timing at which to switch the oscillation mode. The determination as to whether or not being the switching timing is performed based on, for example, information acquired from the machining program. The information acquired from the machining program is an oscillation-off command indicating that the oscillation machining is ended, a command indicating a change in a movement command point, or the like. Alternatively, the determination as to whether or not being the switching timing may acquire the oscillation command and/or superposition command, and perform determination based on a change in the value(s) of the command(s). As described above, various methods can be selected to determine whether or not to switch the oscillation mode.

The filter coefficient calculation unit 33 calculates a filter coefficient for setting a filter to be applied. It should be noted that the method of setting the filter coefficients will also be described later.

When the switching timing is determined, the filter application unit 34 executes filter processing on the command for driving the motor 2. In the first embodiment, the filter application unit 34 performs filter processing on the speed command outputted from the position control unit 14.

Next, the setting of the filter time constant and the application time of the filter applied by the filter application unit 34 will be described. The filter time constant and the application time are set in consideration of the effect of shock reduction at the time of switching the oscillation mode, and the influence of the filter on each control system. For example, the filter time constant t is set to approximately 1 to 16 [ms], and the application time to is set to approximately τ to 4τ (1 to 64 [ms]). Considering that the first-order low-pass filter is applied as the filter in the control sampling period T=1 [ms], the cut-off frequency f becomes 10 to 159 [Hz] and the coefficient K becomes 0.37 to 0.94. It should be noted that the sampling period T=1 [ms] is merely an example, and the numerical value of the sampling period may be in a range satisfying T≤τ.

The first-order low-pass filter can be obtained by the following equation. In the following equation, y(n) represents an output at time n, x(n) represents an input at time n, and K represents a filter coefficient.

$$y ( n ) = ( 1 - K ) \times x ( n ) + K \times y ( n - 1 ) \qquad Equation 1$$

The filter coefficient K can be obtained by the following equation. In the following equation, f [Hz] represents a cut-off frequency, and T [s] represents a sampling period. The filter coefficient calculation unit 33 calculates a filter coefficient using the following equation.

$$K = exp ( - 2 π fT ) \qquad Equation 2$$

The cut-off frequency f [Hz] can be obtained by the following equation. In the following equation, τ [s] represents a time constant.

$$f = \frac{1}{2 πτ} \qquad Equation 3$$

Here, the relationship between the filter application time and convergence will be described. The application time of the filter is the time for which actually filtering, and the application time does not affect the filter coefficient K. However, when the application time is set to be short with respect to the time constant, the convergence (index indicating how close to reaching the equilibrium state) becomes worse, the commands at the time when the filter turned off is likely to become discontinuous, and there is a concern over a shock occurring. The application time preferably takes into account the degree of convergence.

The degree of convergence can be determined by the following equation. In the following equation, r represents a convergence rate, t0 [s] represents the application time, and τ [s] represents the time constant. In this equation, it can be regarded that r converges as approaching 1. For example, in a case where the application time t0=τ, then r=0.63 and converges to 63 [%]. In the case of t0=2τ, then r=0.86 and converges to 86 [%]. In the case of t0=3τ, then r=0.95 and converges to 95 [%]. In the case of t0=4τ, then r=0.98, and reaches 98 [%]. The degree of convergence is adjusted in consideration of the shock occurring in the machine tool. For example, when the convergence is desired to be 90%, the application time t0 [s] and the time constant τ [s] may be set so that t0=3τ.

$$r = 1 - exp ( - \frac{{t}_{0}}{τ} ) \qquad Equation 4$$

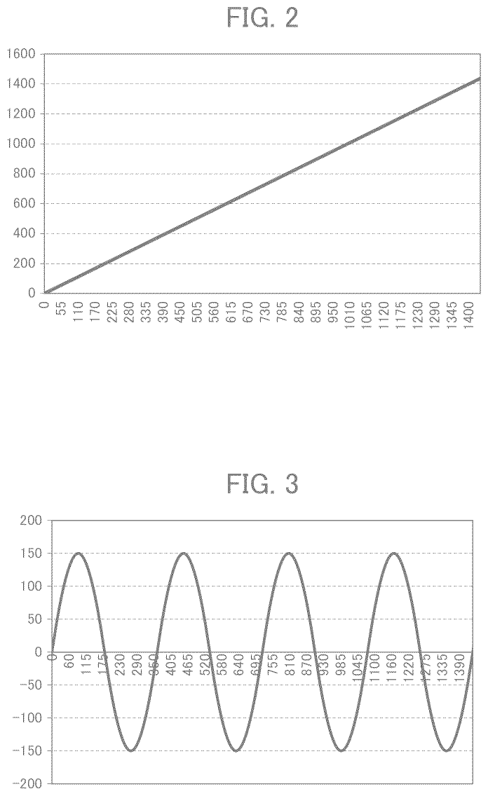

Next, the shock at the time of an oscillation mode change that has occurred in the conventional technology will be described using the graphs of FIGS. 2 to 6. It should be noted that, in the following graphs, the vertical axis indicates the tool position, and the horizontal axis indicates the oscillation phase such as the spindle angle.

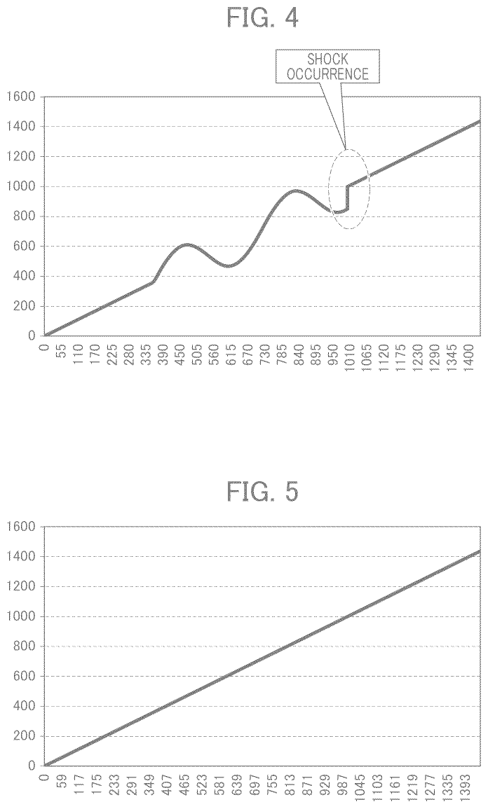

FIG. 2 is a graph showing a movement command. FIG. 3 is a graph showing a sine wave oscillation command. FIG. 4 is a graph of a superposition command obtained by superimposing a movement command (graph of FIG. 2) and an oscillation command (graph of FIG. 3) of a conventional motor control device. As shown in the graph of FIG. 4, when the timing at which the oscillation ends or the timing at which the path of the oscillation changes is not at a multiple of the oscillation phase of 0 degrees, 180 degrees or the like, since the superposition of the oscillation command disappears, the superposition command changes rapidly, and a sharp change in acceleration based on the change in the superposition command occurs. A sharp change in acceleration is a cause for a physically excessive load on the machine tool occurring.

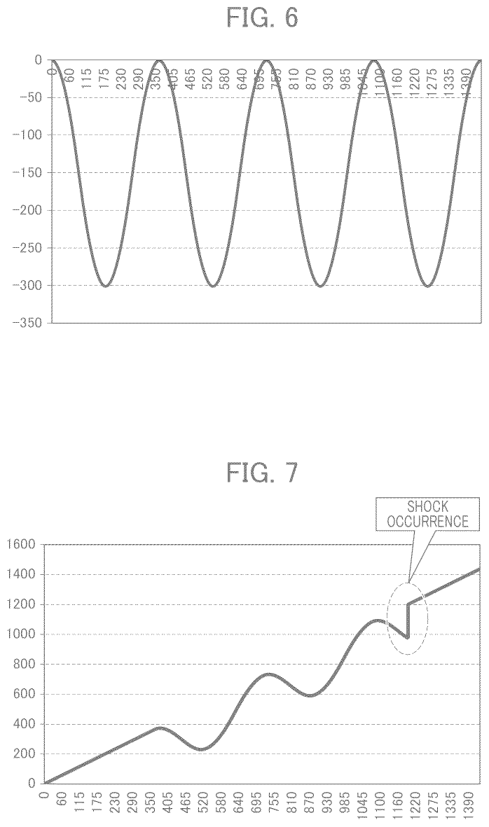

FIG. 5 is a graph showing a movement command, and FIG. 6 is a graph showing an offset cosine wave oscillation command. FIG. 7 is a graph of a superposition command obtained by superimposing the movement command (graph of FIG. 5) and the oscillation command (graph of FIG. 6) of a conventional motor control device. Also in the graph of FIG. 7, there is a similar relationship between the switching timing and the oscillation phase, and there is concern over a physical load generating on the machine tool depending on the oscillation phase when the switching timing occurs.

In this regard, according to the motor control device 1 for the machine tool that controls the motor 2 to perform oscillation machining according to the first embodiment, the following effects are exerted.

The motor control device 1 for a machine tool according to the present embodiment includes: the oscillation command calculation unit 12 that calculates an oscillation command based on a movement command and an oscillation condition; an oscillation mode switching determination unit 32 (switching determination unit) that determines an oscillation end or a switching timing of a machining path; a filter time constant/application time setting unit 31 (setting unit) that sets a time constant τ and an application time to of a filter; a filter coefficient calculation unit 33 that calculates a filter coefficient K based on the time constant τ set by the filter time constant/application time setting unit 31; and a filter application unit 34 that applies a filter of the filter coefficient K to a command for driving the motor 2 for the application time t0, when determined as the switching timing by the oscillation mode switching determination unit 32. As a result, even if the oscillation ends at a timing at which a sharp change in acceleration is likely to occur, or the machining path changes, the filter application unit 34 performs the filter processing for the application time on the command value for respect to the command for driving the motor 2. Therefore, it is possible to avoid a sharp change in acceleration at the switching timing when the oscillation phase is not 0 degrees, 180 degrees, or the like, and thus it is possible to effectively reduce the shock occurring in the machine tool.

In addition, in the present embodiment, the command for driving the motor to which the filter is applied is a speed command for performing speed control. As a result, even if the oscillation mode is switched at a timing at which the oscillation phase is not 0 degrees, 180 degrees, or the like, the filter is applied to the speed command for performing the speed control, and the occurrence of a sharp change in acceleration can be avoided.

In addition, the present embodiment further provides a learning controller 13 that performs learning control based on the position deviation. Accordingly, since the position deviation with respect to the oscillation command becomes larger as the oscillation frequency becomes higher, the followability with respect to the periodic oscillation command can be improved by performing compensation by learning control by the learning controller.

### SECOND EMBODIMENT

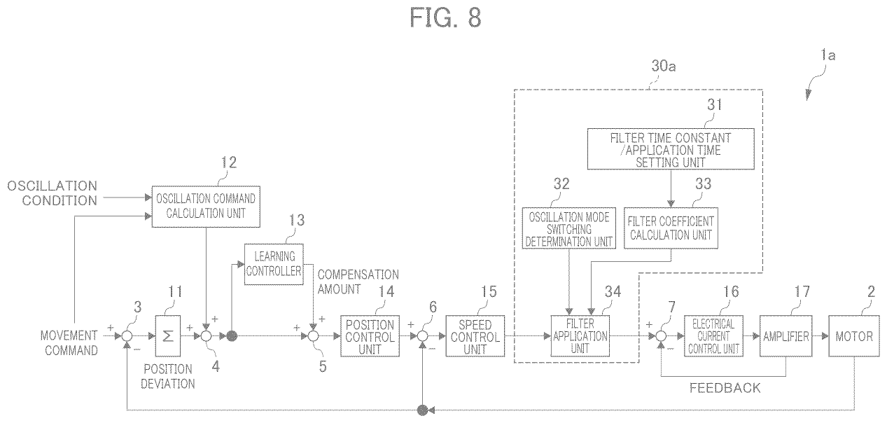

FIG. 8 is a functional block diagram of a motor control device 1a for a machine tool according to a second embodiment. As illustrated in FIG. 8, the motor control device 1a for a machine tool according to the second embodiment is different from the motor control device 1 of the machine tool according to the first embodiment in the command for a filter processing unit 30a to apply a filter, and the other configurations thereof are shared with those of the first embodiment.

In the second embodiment, the filter processing unit 30a is disposed between the speed control unit 15 and the electrical current deviation processing unit 7. The electrical current command value outputted from the speed control unit 15 is outputted to the motor 2 via the amplifier 17, and serves as a command for determining the torque of the motor 2. The filter application unit 34 of the filter processing unit 30a performs filter processing on the electrical current command (torque command) outputted from the speed control unit 15, when determined by the oscillation mode switching determination unit 32 as being the oscillation mode switching timing, similarly to the first embodiment.

As described above, in the second embodiment, the command for driving the motor 2 to which the filter is applied is an electrical current command value serving as the command for controlling the torque. Thus, by the filter being applied to the command for controlling the torque (electrical current command), the command for driving the motor 2 is a command made in consideration of the switching timing, and the occurrence of a sharp change in the acceleration can be avoided. It should be noted that the present invention is not limited to the configuration of the second embodiment, and the command for controlling the torque may be a command outputted from the electrical current control unit 16 or a command outputted from an amplifier.

### THIRD EMBODIMENT

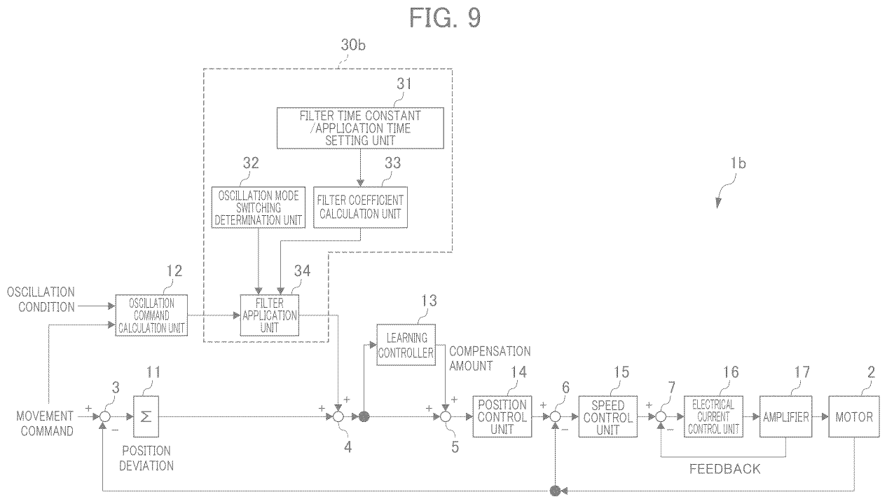

FIG. 9 is a functional block diagram of a motor control device 1b for a machine tool according to a third embodiment. As illustrated in FIG. 9, the motor control device 1b for the machine tool according to the third embodiment is different from the motor control device 1 of the machine tool according to the first embodiment in the command for the filter processing unit 30b to apply the filter, and the other configurations thereof are shared with those of the first embodiment.

In the third embodiment, the filter processing unit 30b is disposed between the oscillation command calculation unit 12 and the command synthesis unit 4. The filter application unit 34 of the filter processing unit 30b performs the filter processing on the oscillation command value outputted from the oscillation command calculation unit 12, when determined by the oscillation mode switching determination unit 32 as being the oscillation mode switching timing, similarly to the first embodiment. The oscillation command filtered by the filter application unit 34 is outputted to the command synthesis unit 4, and is superimposed on the movement command by the command synthesis unit 4.

In this way, with the third embodiment, the command for driving the motor 2 to which the filter is applied is the oscillation command before being superimposed on the movement command. By the filter being applied to the oscillation command before being superimposed on the movement command, the command for driving the motor 2 is a command made in consideration of the switching timing, and occurrence of a sharp change in acceleration can thereby be avoided.

### FOURTH EMBODIMENT

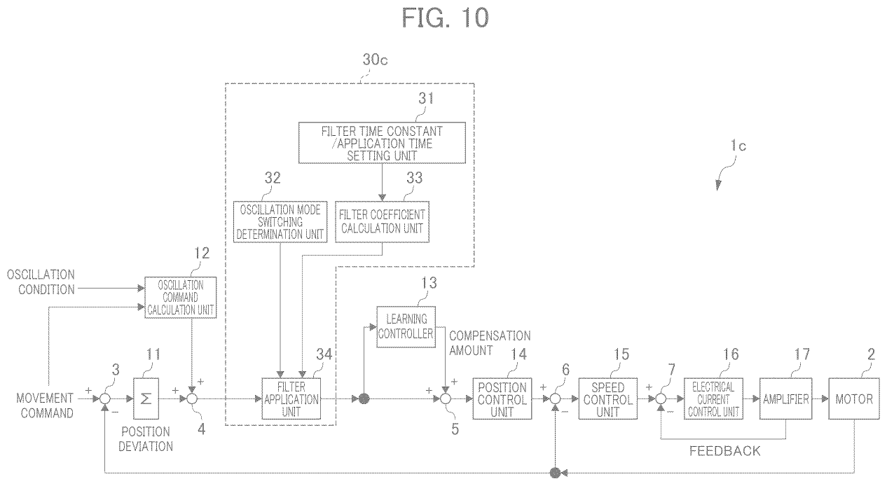

FIG. 10 is a functional block diagram of a motor control device 1c for a machine tool according to a fourth embodiment. As illustrated in FIG. 10, the motor control device 1c for the machine tool according to the fourth embodiment is different from the motor control device 1 for the machine tool according to the first embodiment in a command for driving the motor 2 to which the filter processing unit 30c applies the filter, and the other configurations thereof are shared with those of the first embodiment.

In the fourth embodiment, the filter processing unit 30c is disposed between the command synthesis unit 4 and the learning compensation value adding unit 5. The filter application unit 34 of the filter processing unit 30c performs the filter processing on the superimposed command value outputted from the command synthesis unit 4, when determined by the oscillation mode switching determination unit 32 as being the oscillation mode switching timing, similarly to the first embodiment. The filtered superposition command is outputted to the learning compensation value adding unit 5.

In this way, with the fourth embodiment, the command for driving the motor 2 to which the filter is applied is a superposition command obtained by superimposing the oscillation command on the movement command. By the filter being applied to the superposition command obtained by superimposing the oscillation command on the movement command, the command for driving the motor 2 is a command made in consideration of the switching timing, and the occurrence of a sharp change in acceleration can thereby be avoided.

It should be noted that the present disclosure is not limited to the above-described embodiments, and modifications and improvements within a range which can achieve the object of the present disclosure are included in the present disclosure.

For example, although an example has been described in the above embodiment in which the filter applied by the filter application unit 34 is a first-order low-pass filter, the present invention is not limited thereto. For example, another filter such as a second-order or higher low-pass filter or a band-pass filter may be applied.

### EXPLANATION OF REFERENCE NUMERALS

1, 1a, 1b, 1c motor control device for machine tool
12 oscillation command calculation unit
31 filter time constant/application time setting unit
32 oscillation mode switching determination unit
33 filter coefficient calculation unit
34 filter application unit

1. A motor control device for a machine tool that controls a motor to perform oscillation machining, the motor control device comprising:
an oscillation command calculation unit that calculates an oscillation command from a movement command and an oscillation condition;
a switching determination unit that determines an oscillation end or a switching timing of a machining path;
a setting unit that sets a time constant and an application time of a filter;
a filter coefficient calculation unit that calculates a coefficient of a filter based on a time constant which was set by the setting unit; and
a filter application unit that, in a case of being determined by the switching determination unit as being the switching timing, applies a filter of the filter coefficient to a command for driving the motor during the application time.

2. The motor control device according to claim 1, wherein the command for driving the motor to which a filter is applied is a speed command for performing speed control.

3. The motor control device according to claim 1, wherein the command for driving the motor to which a filter is applied is a command for controlling torque.

4. The motor control device according to claim 1, wherein the command for driving the motor to which a filter is applied is an oscillation command prior to superimposing on a movement command.

5. The motor control device according to claim 1, wherein the command for driving the motor to which a filter is a superposition command obtained by superimposing an oscillation command on a movement command.

6. The motor control device according to claim 1, further comprising a learning controller that performs learning control based on a position deviation.
